(19) United States
(12) Patent Application Publication
(10) Pub. No.: US 2012/0217315 A1
(43) Pub. Date: Aug. 30, 2012

(54) SYSTEM FOR CONTROLLING TEMPERATURES OF MULTIPLE ZONES IN MULTIPLE STRUCTURES

(76) Inventors: Dane Camden Witbeck, Houston, TX (US); Lewis Dryden Wight, Houston, TX (US)

(21) Appl. No.: 13/033,922

(22) Filed: Feb. 24, 2011

(51) Int. Cl. G05D 23/00

(52) U.S. Cl. 236/51

(57) ABSTRACT

A system for controlling the temperature of multiple zones is disclosed, wherein the system includes a remotely located server and two or more structures, and wherein each structure has a gateway, at least one temperature sensor, at least one heating ventilation and air conditioning system, at least one controller, at least one air obstruction device, a user input device, and at least one zone.

### BACKGROUND OF INVENTION

1. Field of the Invention

The present invention relates to a system for efficiently controlling the interior temperature of more than one structure, including separate zones in said structures.

2. Background Art

Most traditional zoned heating and cooling systems comprise several components to control the air flow, and therefore temperature, in separate zones in a structure. These components may include an HVAC system, one or several thermostats, remote temperature sensors, electronically-controlled vent registers or inflatable bladders, in-duct pressure sensors, a central control unit with microprocessor, optional displays for user interaction, and a wireless communication system or wired communication system, as well as optional occupancy sensors for control based on human presence. Traditional systems may be configured for easy installation to control cost.

Unfortunately, the amount of processing power required for each individual structure means that the control system is prohibitively expensive for the average home owner to economically adopt these traditional zoned heating and cooling systems. Additionally, complex data analysis enabling advanced features has not been implemented because the cost of such a robust in-home controller that could handle the required memory and processing power is too high. One may argue that home computers possess vast amounts of storage and processing power currently. However, the setup and maintenance of a home computer for this purpose is too time-consuming and complicated for the average home owner. Additionally, home internet service providers charge a substantial premium for a home computer to operate as a server by assigning the device a static IP address. While various types of solutions for this problem have been considered, implementing them may violate the user agreement between a home owner and the internet service provider and/or is too difficult to set up. Additionally, even if all of the above were overcome, the cost of a dedicated computer in the home for the purpose of zoned home HVAC control is still prohibitive for wide spread adoption of such technology.

### SUMMARY OF INVENTION

In one aspect, embodiments described herein relate to a system for controlling the temperature of multiple zones, wherein the system has a remotely located server and two or more structures, wherein each structure has a gateway, at least one temperature sensor, at least one heating ventilation and air conditioning system, at least one controller, at least one air obstruction device, a user input device, and at least one zone.

In another aspect, embodiments described herein relate to a system for controlling the temperature of multiple zones, wherein the system has a remotely located server and two or more structures, wherein each structure has a gateway, at least one temperature sensor, at least one heating ventilation and air conditioning system, at least one combined controller and user input device, at least one air obstruction device, and at least one zone.

Other aspects and advantages of the invention will be apparent from the following description and the appended claims.

### BRIEF DESCRIPTION OF DRAWINGS

FIG. 1 is a diagram of a zoned heating and cooling system according to embodiments herein.

FIG. 2 is a diagram of a zoned heating and cooling system according to other embodiments herein.

FIG. 3 is a diagram of a structure according to embodiments herein.

FIG. 4 is an illustration of a vent register according to embodiments described herein.

### DETAILED DESCRIPTION

The system disclosed herein solves the problems discussed in the background section by moving all or a portion of the control logic, and all data caching and analysis from an in-home controller to a remotely located server that is configured to automatically use more computing resources or less depending on real-time demand. According to embodiments of the present invention, an internet-connected server monitors many low-memory, low-computing power, and low-cost gateways, in multiple structures, and contains a program to store and analyze the gathered data to economically enable features that were never-before possible with the limited processing power of an in-home controller. Additionally, the present invention includes temperature sensors, a thermostat controller, an air obstruction device such as an electronically controlled vent register or inflatable bladder, optional occupancy sensors, and optional user input device where said user input device is in communication with the central server and/or the local gateway. The system disclosed herein also has the advantage of gathering data from outside the structure to further enhance the computer algorithm for controlling the users' energy use as it relates to in-home heating and cooling systems.

According to an exemplary zoned heating and cooling system of the present disclosure, a first structure may include a gateway, at least one temperature sensor, at least one heating ventilation and air conditioning system, at least one controller, at least one air obstructing device (e.g., vent register or inflatable bladder), a user input device, and at least one zone. The gateway and/or a user input device may communicate with a server, wherein a program and database on the server interpret and store data communicated from the gateway and/or user input device. A second, third, fourth, etc. structure and corresponding zoned heating and cooling systems are also in communication with the program and database on the server via a gateway and/or user input device. These terms are described in more detail below.

### Structure

As used herein, a structure refers to a free-standing building, such as a residential dwelling, an office building, a retail building, etc., wherein each structure may have more than one divided areas, i.e., zones, therein. Alternatively, a structure may be defined as a unit within a building, such as an apartment building, a condominium, a duplex, a shared-office building, or other building having separately owned or rented space. For example, in a condominium building, each condominium may be referred to as a separate structure, which may have more than one divided areas therein.

### Zone

Each structure may be divided into at least one area, referred to herein as a zone. A zone may be defined within the structure by strategic placement of a remote temperature sensor and at least one associated air obstruction device installed at the air outlet(s) in the area to limit the flow of air to the area upon request by the server. In an exemplary structure, zones may be defined in each room of the structure, wherein each room has a temperature sensor and at least one associated air obstruction device, such as a motorized vent register. Alternatively, two adjacent rooms in a structure may constitute a single zone, wherein one temperature sensor and at least one air obstruction device is installed.

A structure may be fully zoned, meaning that every part of the structure has air obstructing devices installed and associated temperature sensors to allow control of airflow to multiple defined zones of the structure independently. Alternatively, the structure may be partially-zoned. In a partially zoned structure, airflow is not obstructed to some parts of the structure, and flows freely when the HVAC system fan is on.

### Temperature Sensor

As used herein, a temperature sensor may refer to an electronic device that measures a temperature and submits that information over wireless protocol to the gateway. An exemplary temperature sensor may include a thermistor, wherein a change in temperature induces a change in resistance, which may be digitally read as the change in temperature. Other temperature sensors may include temperature sensing integrated circuits, optical temperature sensors, thermal imaging temperature sensors, etc.

Each zone (i.e., a divided area within a structure) may include a temperature sensor to relay the temperature of that zone to the gateway, which may then be uploaded to the server for storage and analysis. Based upon the measurements from the temperature sensor of a zone, the at least one air obstruction device may be regulated to let in more or less heated or cooled air, until the temperature sensor detects the desired user inputted limitations. Alternatively, an algorithm executed on the server may be designed to trigger movement of the air obstruction device to let in more or less heated or cooled air, based on inputted data points from inside and/or outside the structure. Algorithms according to embodiments disclosed herein are described in more detail below.

### Air Obstruction Device

As used herein, an air obstruction device may refer to an electronically-controlled vent register, an in-duct inflatable bladder, an in-duct butterfly valve, or any other electro-mechanical device designed to block air from one duct and redirect it elsewhere in the HVAC system. Each air obstructing device may be controlled by the associated temperature sensor within the zone via communication with the server via the gateway, as described above.

In an exemplary embodiment, an air obstruction device may be a vent register. The term “vent register” may be interchangeably used with the term “vent,” both of which may refer to a ventilated covering to an HVAC duct. A vent may have louvers that open, close, or partially close to allow precise control of the flow of air through the vent opening to a zone. The louvers may be controlled by a motor, such as a DC stepping motor, servo, mechanical actuator, etc. The motor may receive input and send outputs to a wireless chip which communicates wirelessly with the gateway. The electronic components of the vent (e.g., the motor and wireless chip) may be battery-powered or powered by direct plug-in to the structure's electrical system in order to open or close the louvers.

In another exemplary embodiment, an air obstruction device may be an inflatable bladder. An inflatable bladder, as referred to herein, is a device that inflates to obstruct or restrict airflow through a duct. The device may be inflated by any inert gas (e.g. air, nitrogen, argon) by methods known in the art. The inflatable bladder may receive input and send outputs to a wireless chip which communicates wirelessly with the gateway, and may be battery-powered or powered by direct plug-in to the structure's electrical system in order to inflate or deflate the bladder.

### Heating, Ventilation And Cooling System

As used herein, a heating, ventilation and cooling (“HVAC”) system may refer to a group of components used to alter the air temperature or air humidity level in a structure. In one embodiment, the refrigeration cycle is used to accomplish the task of cooling the structure by use of a condenser, evaporator, expansion valve, refrigerant, and compressor. In other embodiments, the air temperature is altered by use of a furnace, heated and circulated water, geothermal cycle, or heat pump. Ducts are used to transport heated or cooled air to different rooms in the structure. Exemplary HVAC systems are described in U.S. Pat. Nos. 4,187,543, 4,100,763, and 6,655,163, for example.

### Controller

A controller, as referred to herein, may be an electronic device for routing current to different components of the heating and cooling system to manipulate functions of the system. For example, the current may be routed to the air conditioner and fan simultaneously to provide cool air to the structure. Alternatively, the current may be routed to the heater and fan simultaneously to provide hot air to the structure. One skilled in the art will appreciate that the number and type of possible configurations for the particular structures heating and cooling system may vary (e.g., multi-stage fans, multi-stage cooling systems, multi-stage heating systems, in-floor heating systems, heat pumps, evaporative cooling system, geothermal systems, etc.)

### User Input Device

A user input device, as referred to herein, may be an electronic device for capturing user desired settings and transmitting the captured data to the server. One skilled in the art may appreciate that the data may be transmitted in various ways, depending on the user input device and available internet connection.

According to some embodiments the user input device may be combined with the controller to create one device performing both functions. In such embodiments, the combined controller and user input device may or may not be in communication with the gateway to send commands or user inputted data to the server. The data is processed in the server and selected commands or data is sent back to the combined controller and user input device through the gateway or other internet connection for controlling HVAC system settings.

According to other embodiments, the user input device is separate from the controller. In such embodiments, the user input device may bypass communication with the gateway and directly communicate through the internet to the program on the server. The user inputted data is processed in conjunction with data gathered by the other devices described herein or from other outside sources, such as data about upcoming weather conditions, utility pricing, etc. Based on the data gathered, an algorithm (part of the program) on the server may determine which commands to send back to the structure via the gateway and when to execute such commands. For example, a user input device, which may or may not be separate from the controller, may include a cellular phone to transmit user inputted data via the cellular carrier's wireless data network. A home computer may also be a user input device, transmitting data via an internet service provider's network, such as DSL, cable, fiber optic, wireless mesh network, wireless data network, telephone lines etc.

### Gateway

As used herein, a gateway refers to a device that communicates data received from devices of the presently disclosed heating and cooling system to a remotely located server through a user's internet service provider in any industry-standard secure manner. For example, the gateway may communicate gathered data from temperature sensors, air-obstruction devices, a thermostat controller, optional occupancy sensors, user input device, and/or other sensors and inputs to the remotely located server for storage and analysis. Additionally, a gateway receives commands from the server and communicates those to the end devices. For example, if the program on the server calculates the user may save money due to a price spike in the cost of electricity, it would send a command to the gateway to shorten the HVAC system cycle time. The gateway would communicate the command to the controller. The gateway may communicate with the end devices wirelessly. Exemplary wireless network protocols include IEEE 802.14 (Wi-Fi), IEEE 802.15 (Bluetooth), IEEE 802.15.4 (Zigbee or Z-wave), Wi-Max, or other cellular-based networks. The gateway may contain an embedded program to manage device connectivity and wireless communication. The embedded program may perform simple commands such as on/off of devices at the request of the remote server. Advantageously, a gateway may provide low-computing power, low memory, and low cost to allow the system to be as economical as possible. Exemplary gateways include the Digi X2, Digi X4, digimesh gateway, Wi-Fi router or cellular node.

### Server

As used herein, a server, or cloud server, may include computing resources that are dynamically expandable in response to a peak in demand load. In addition, the resources may be dynamically balanced across dynamically created computing resources to ensure efficiency and speed of operation. Exemplary services of cloud computing platforms include Amazon Web Services, Microsoft Azure, Google App Engine, RackSpace Cloud, etc. Similar systems are also described in, for example, U.S. Patent Application No. 2009/0300057. Cloud storage and computing methods on servers may be described, for example, in U.S. Pat. Nos. 6,714,968, 6,735,623, and 6,952,724. In other embodiments, the server may be dedicated computing resources that are not expandable. Various server systems are known in the art, all of which may be appropriately used with the heating and cooling system of the present disclosure.

In some embodiments, the remotely-located server and accompanying database and computational program is able to alter the vent operation in various zones of a particular structure to optimize energy use and comfort for the inhabitants based on analysis of and algorithm output from data sets collected by the computational program. The data sets may include, for example, data collected from within each of the structures, such as the users' recent habits of arrival or departure, temperatures in each zone in each structure, historical temperature in each zone in each structure, energy used in kilowatt hours historically or recently, user inputs of desired energy use, individual appliance energy use, monetary budget over a certain time frame, user-inputted desired temperature for each zone, energy use by the user's peers, desired temperature setting of user's peers, pressure in the structures' duct work, historical data about pressure build-up in the duct-work, and average settings in comparable structures, as well as data collected from outside of the structures, such as recent electricity pricing gathered from local utilities or Retail Electric Providers, outside temperature, changing outside temperature based on upcoming weather conditions, or other analysis requiring processing of data sets (historical or otherwise) and not insignificant computing resources. One skilled in the art will recognize that the scope of the invention is not intended to be limited by the list of potential input variables. Additionally, by the said computer resources and program being remotely located, automatically expandable, and connected to many gateways at multiple structures, there is a substantial net gain in efficiency of the overall system and therefore an overall lower cost of adoption for users when compared to traditional zoned heating and cooling systems.

Located on the server, a computation program may be written to collect and analyze data collected from the heating and cooling system of the present disclosure as well as outside data sources, as described above. According to embodiments described herein, the computation program on the server may include an algorithm used to determine the most effective setting of each device in the heating and cooling system of the present disclosure in order to obtain a desired user outcome. For example, a user may want to set a warmer temperature in one zone of a structure and a cooler temperature in another zone of the same structure. Alternatively, a user may desire to not spend more than a pre-determined amount on heating and cooling costs over a specified time period. By collecting data on average run-time of the users' heating and cooling system, and comparing that data with the amount spent on electricity historically while running the heating and cooling system, an algorithm may determine the cost of running the heating or cooling system and thereby determine the heating and cooling system settings in order to meet the users' limitations.

### Other In-Structure Devices

Other in-structure devices may be used in combination with the heating and cooling system described herein as additional forms of energy management and data gathering. Exemplary in-structure devices may include a motion sensor, appliance monitoring device, lighting controls, cameras, occupancy sensor, light sensor, humidity sensor, pressure sensors, outlet boxes, on/off control devices to turn on or off electronically-controlled appliances, etc. A motion or occupancy sensor may be used, for example, to detect user's habits of arrival or departure or to activate temperature change through the HVAC system.

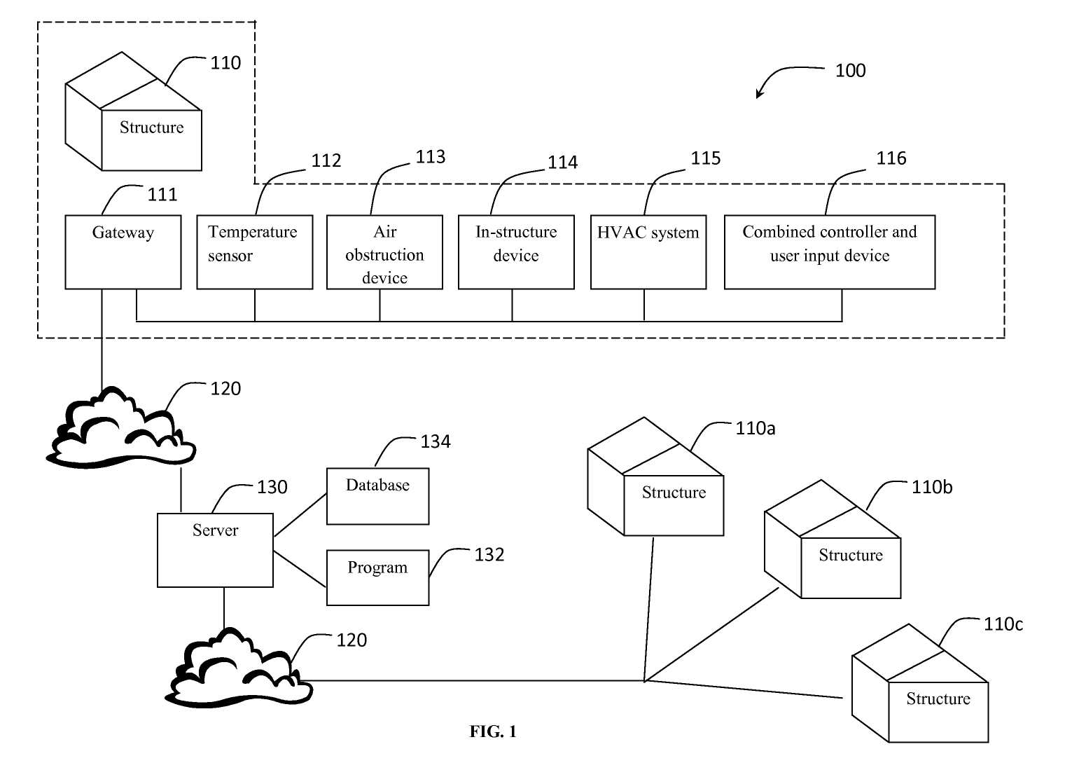

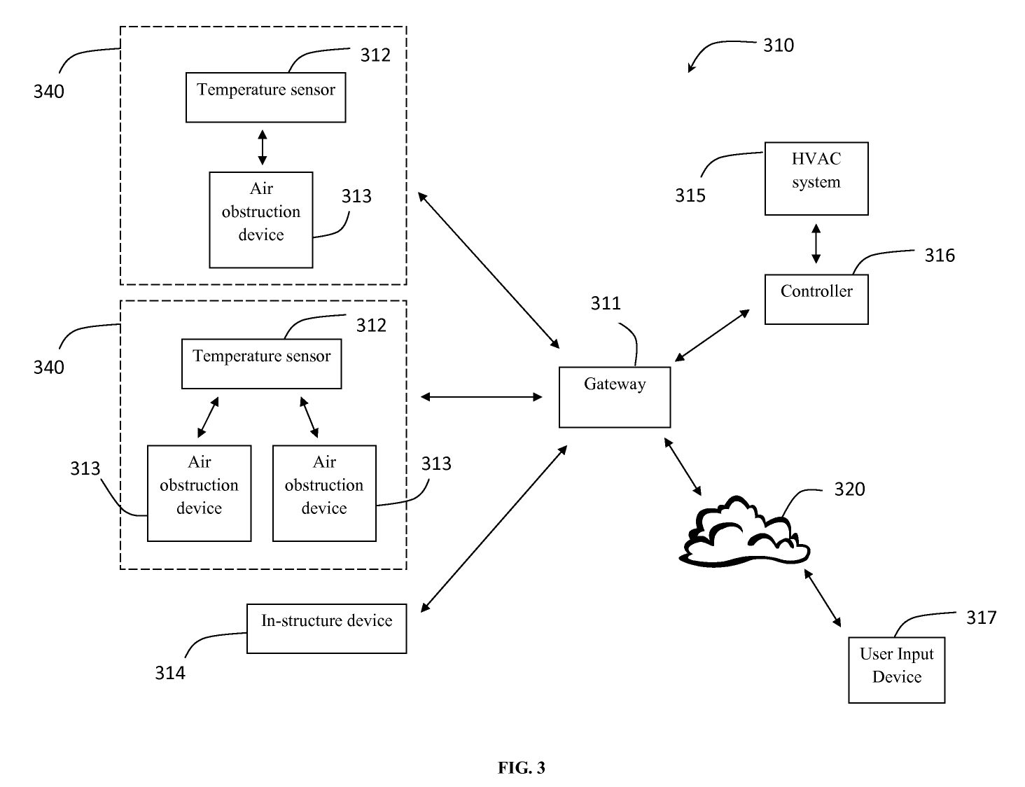

Referring now to FIG. 1, a diagram of a zoned heating and cooling system 100 according to the present disclosure is shown. Beginning at the structure level, a first structure 110 includes a gateway 111, at least one temperature sensor 112, at least one HVAC system 115, at least one combined controller and user input device 116, at least one air obstruction device 113, and at least one zone (shown in FIG. 3). As shown, the first structure 110 may also include at least one in-structure device 114, such as a motion sensor. The at least one temperature sensor 112, the at least one air obstruction device 113, the at least one in-structure device 114, the at least one HVAC system 115, and the at least one combined controller and user input device 116 are all in communication with the gateway 111. The gateway 111 is, in turn, in communication via the internet 120 with a server 130, wherein the server has a computation program 132 and a database 134. A second structure 110a, a third structure 110b, a fourth structure 110c, and more may also be in communication through a corresponding gateway in each structure to the server 130 via the internet 120.

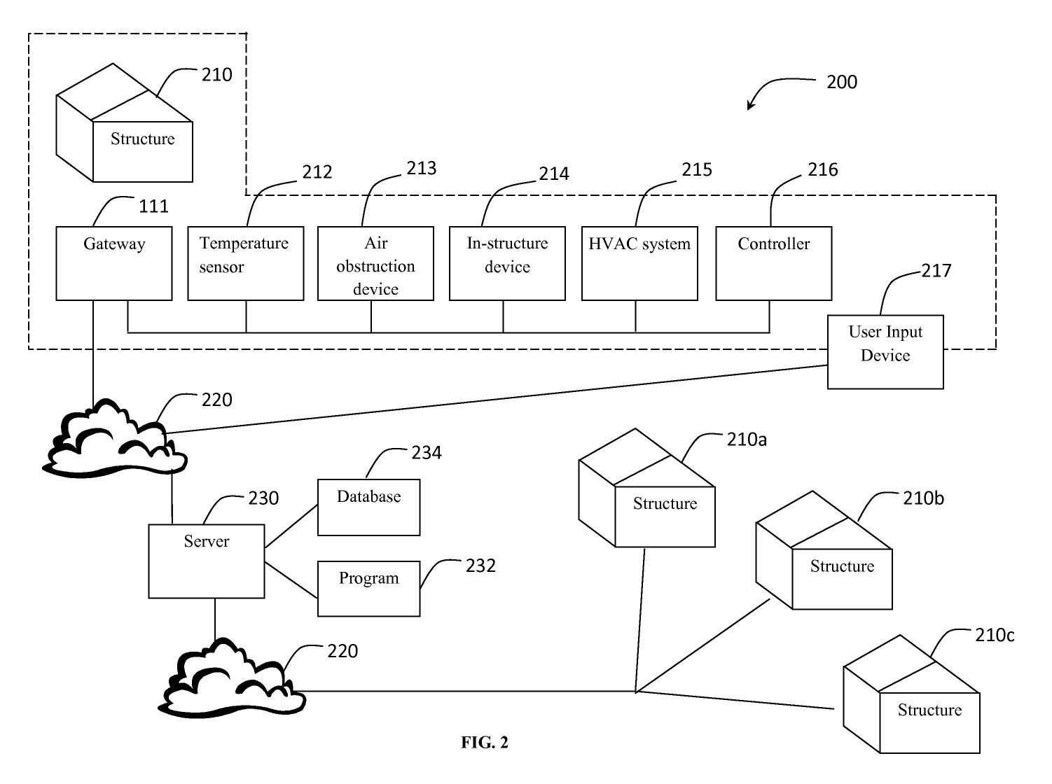

Another embodiment of a zoned heating and cooling system 200 according to the present disclosure is shown in FIG. 2, wherein at least one structure 200 has a user input device separate from the controller. Beginning at the structure level, a first structure 210 includes a gateway 211, at least one temperature sensor 212, at least one HVAC system 215, at least one controller 216, at least one user input device 217, at least one air obstruction device 213, and at least one zone (shown in FIG. 3). As shown, the first structure 210 may also include at least one in-structure device 214, such as a motion sensor. The at least one temperature sensor 212, the at least one air obstruction device 213, the at least one in-structure device 214, the at least one HVAC system 215, and the at least one controller 216 are all in communication with the gateway 211. The gateway 211 is, in turn, in communication via the internet 220 with a server 230, wherein the server has a computation program 232 and a database 234. The at least one user input device 217 is in direct communication with the server 230 via any available internet connection. A second structure 210a, a third structure 210b, a fourth structure 210c, and more may also be in communication through a corresponding gateway in each structure to the server 230 via the internet 220.

FIG. 3 shows a diagram of an exemplary structure 310 that may be linked through a gateway 311 to a server (not shown) via the internet in a heating and cooling system of the present disclosure. In the structure 310, at least one zone 340 is defined by a combination of a temperature sensor 312 and at least one air obstruction device 313. The temperature sensors 312 and air obstruction devices 313 of each zone 340 are in communication with a gateway 311, which relays the communicated data with the server (shown in FIGS. 1 and 2) via the internet 320. At least one in-structure device 314 may also be in communication with the gateway 311. At least one HVAC system 315 may be in communication with at least one controller 316, which is in turn, in communication with the gateway 311. The embodiment shown in FIG. 3 shows one controller in communication with one HVAC system. However, in other embodiments, a structure may have more than one HVAC system, wherein each HVAC system has a controller associated with it. As shown, a user input device 317 is a separate device from the controller 316 and sends commands from the user to the server via the internet 320, which may be processed by the computation program on the server. The processed inputted user data may then be relayed back to the gateway 311 via the internet 320 to execute the necessary commands on corresponding in-structure devices 314 and zones 340. Alternatively, as shown in FIG. 1, a user input device may be combined with a controller.

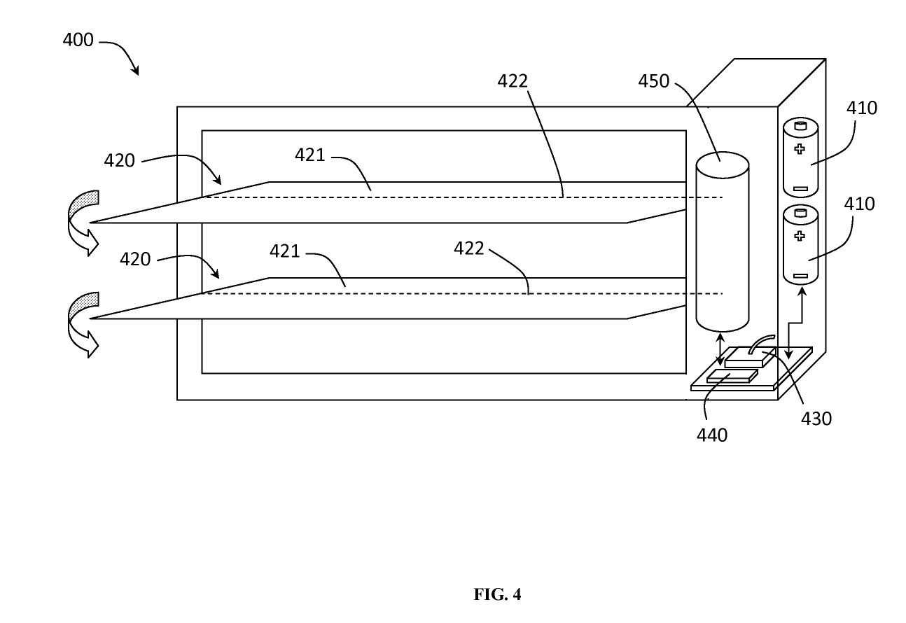

Referring now to FIG. 4, a vent register 400 according to embodiments disclosed herein includes a power source 410, a louver system 420, a wireless communication system 430, a microcontroller 440 configured to send and receive signals with the wireless communication system 430, and an electronic actuator 450 configured to control the louver system 420 in response to communication received from the microcontroller 440. A louver system 420 may include a plurality of louvers 421, which are rotated about an axis 422 to a fully open position (shown in FIG. 4), a partially open position, or a completely closed position by the actuator 450.

Advantageously, embodiments of the present disclosure may provide complex data analysis on user habits over time, tracking changes in duct pressure in the structure based on season or outside temperature, on/off control of the system based on current utility rates, and other features listed above at a lower cost and easier installation than methodologies previously attempted to control such features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A system for controlling the temperature of multiple zones, comprising:
a remotely located server; and
two or more structures, wherein each structure comprises:
a gateway;
at least one temperature sensor;
at least one heating ventilation and air conditioning system;
at least one controller;
at least one air obstruction device;
a user input device; and
at least one zone.

2. The system of claim 1, wherein the at least one air obstruction device is a vent register comprising:
a power source;
a louver system;
a wireless communication system;
a microcontroller configured to send and receive signals with the wireless communication system; and
an electronic actuator configured to control the louver system in response to communication received from the microcontroller.

3. The system of claim 1, wherein the at least one air obstruction device is an inflatable bladder.

4. The system of claim 1, wherein the server comprises a database and a computational program.

5. The system of claim 4, wherein the computational program collects data sets from outside the two or more structures.

6. The system of claim 4, wherein the computational program collects data sets from within each of the two or more structures.

7. The system of claim 1, wherein the server comprises computing resources that are automatically expandable.

8. The system of claim 1, wherein at least one structure further comprises a motion sensor.

9. The system of claim 1, wherein the user input device is a website accessed by an internet connected device.

10. The system of claim 1, wherein the user input device is an application accessed by an internet connected device.

11. A system for controlling the temperature of multiple zones, comprising:
a remotely located server; and
two or more structures, wherein each structure comprises:
a gateway;
at least one temperature sensor;
at least one heating ventilation and air conditioning system;
at least one combined controller and user input device;
at least one air obstruction device; and
at least one zone.

12. The system of claim 11, wherein the at least one air obstruction device is a vent register comprising:
a power source;
a louver system;
a wireless communication system;
a microcontroller configured to send and receive signals with the wireless communication system; and
an electronic actuator configured to control the louver system in response to communication received from the microcontroller.

13. The system of claim 11, wherein the at least one air obstruction device is an inflatable bladder.

14. The system of claim 11, wherein the server comprises a database and a data analysis system.

15. The system of claim 14, wherein the computational program collects data sets from outside the two or more structures.

16. The system of claim 14, wherein the computational program collects data sets from within each of the two or more structures.

17. The system of claim 11, wherein the server comprises computing resources that are automatically expandable.

18. The system of claim 11, wherein at least one structure further comprises a motion sensor.

19. The system of claim 11, wherein the user input device is a website accessed by an internet connected device.

20. The system of claim 11, wherein the user input device is an application accessed by an internet connected device.
